(19) United States
(12) Patent Application Publication
(10) Pub. No.: US 2012/0233334 A1
(43) Pub. Date: Sep. 13, 2012

(54) SHARED MEDIA ACCESS FOR REAL TIME FIRST AND THIRD PARTY CONTROL

(75) Inventors: Robert Eric Braudes, Dracut, MA (US); Joel Michael Ezell, Broomfield, CO (US); Stephen Randall Whynot, Allent, TX (US)

(73) Assignee: AVAYA INC., Basking Ridge, NJ (US)

(21) Appl. No.: 13/041,982

(22) Filed: Mar. 7, 2011

(51) Int. Cl. G06F 15/16

(52) U.S. Cl. 709/227

(57) ABSTRACT

A communication system provides for establishing a communication environment where multiple media applications can share the same communication channel in a communication session. When establishing a communication session, an application or media application can create a token that can include information regarding resources assigned to or to be used with the communication session. The token may then be used and interpreted by other applications. When communicating during a communication session, the applications and/or components negotiate for access to ports or communication channels assigned to the communication session. Thus, two or more applications may use the same port(s) during the session by obtaining the token and accessing the resources assigned to the token. In this way, fewer ports or channels are used by the multiple applications by sharing resources.

### CROSS REFERENCE TO RELATED APPLICATIONS

This application is related to co-pending U.S. application Ser. No. 12/574,604, entitled “Shared Media Access for Real Time First and Third Party Media Control”, filed on Oct. 6, 2009, which is incorporated herein by reference in its entirety for all that it teaches.

### BACKGROUND

In today's telecommunications environments, there are often cases where multiple applications want to provide media, including but not limited to voice, video, text, and content, over the same communications channel. The provision of multimedia over communication channels is part of many communication architectures, including Internet Protocol (IP) Multimedia Subsystem (IMS) architectures. In these IMS systems, there is generally a common media server (or a pool of two or more media servers) that are accessed by a variety of applications. For example, the system can execute a call recording application that is set to record all calls for a specified user. In parallel, the system can execute an Interactive Voice Response (IVR) system that provides a caller with a series of options, for example, an option to search for account information and then be transferred to an agent for live help.

Unfortunately, present systems generally allocate multiple “ports” of media resources, and then daisy-chain these ports together to combine the media of multiple applications. This combination of ports has the obvious shortfall of requiring extra resources to be allocated from a finite pool and creates delays by chaining these resources together. There is also no mediation of the media requests as there is no single point of control, and thus, the media applications can interfere with each other in unpredictable ways. As such, as several applications are executed, the number of ports being used increases, which causes inefficient utilization of resources and creates extra work for the media server.

### SUMMARY

It is with respect to the above issues and other problems that the embodiments presented herein were contemplated. Embodiments described in the present application provide systems and methods for establishing a communication environment where multiple media applications can share the same communication channel. When establishing a communication session, a media application can create a token that can include information regarding resources assigned to or to be used with the communication session. The token may then be used and interpreted by other applications. When communicating during a communication session, the applications and/or components negotiate for access to ports or communication channels assigned to the communication session. Thus, two or more applications may use the same port(s) during the session by obtaining the token and accessing the resources assigned to the token. In this way, fewer ports or channels are used by the multiple applications by sharing resources.

A media “token” can be included in a Session Initiation Protocol (SIP) header to allow applications to utilize the media token to request the media server to take actions on the applications' behalf. The present embodiments provide a brokerless method for creating and interpreting the token. In this approach, the first application in sequence can interface directly with a media server to establish and set up the media session. After communicating with the media server, the application itself can create the media token. This token can contain all of the information that a second application needs to establish a control channel with the media server to issue media requests and receive media events in the same fashion as the first application. For example, systems using a MSML-based media server can include a SIP Contact uniform resource identifier (URI) for an application (used to establish an independent control session) and the associated connection identifier (used to direct requests to the correct resources) in the media token. In general, any media control protocol can be supported if the token contains a protocol identifier, media server address, and an opaque identifier allowing the query of context identifiers to access reserved resources. In other embodiments, a non-opaque token may include all the necessary information about the context identifier, the reserved resources, etc.

Present embodiments also address issues with remote applications that are NOT in sequence. The media token may also be published in Dialog State Events. The publication allows remote applications to monitor these Dialog State Events and leverage the media service to request media operations.

The term “communication session” as used herein refers to any communication or set of communications, whether including audio, video, text, or other multimedia data, between two or more communication endpoints and/or users. Typically, a communication session includes two or more communication endpoints.

The term “communication device” or “communication endpoint” as used herein refers to any hardware device and/or software operable to engage in a communication session. For example, a communication device can be an IP-enabled phone, a desktop phone, a cellular phone, a personal digital assistant, a soft-client telephone program executing on a computer system, etc. In embodiments, the communication endpoint is a computer system as described in conjunction with FIGS. 7 and 8.

The term “feature sequencer” (FS) as used herein refers to any hardware, software, or a combination of hardware and software operable to conduct, manage, execute, or otherwise establish as least a part of a communication session between two or more communication endpoints. The FS may be a server, switch, or computer system as described in conjunction with FIGS. 6 and 7. The communications preferences for a particular user are referenced by the feature sequencer to determine which, if any, features (i.e., media applications) should be incorporated into a communication session for the user. The feature sequencer can actually provide communication features directly into the communication session or the feature sequencer can determine an application sequence which will be invoked during the communication set-up and used during the communication session.

The term “media server” as used herein refers to any hardware, software, or a combination of hardware and software operable to conduct, manage, execute, or otherwise hold a communication session between two or more communication endpoints and/or provide media services or resources to media applications. The media server may be hardware and/or software included in a server, switch, or computer system as described in conjunction with FIGS. 6 and 7.

The term “token” as used herein refers to any data structure or element operable to store information that an application or other component can use to interact with a media server to receive media services or use media resources. In embodiments, the token is a text string operable to be transmitted in a SIP (or other protocol) message. Alternatively, the token can be a part of a database or a data model as described in conjunction with FIGS. 6 and 7.

The term “Session Initiation Protocol” (SIP) as used herein refers to an IETF-defined signaling protocol, widely used for controlling multimedia communication sessions such as voice and video calls over Internet Protocol (IP). The protocol can be used for creating, modifying and terminating two-party (unicast) or multiparty (multicast) sessions consisting of one or several media streams. The modification can involve changing addresses or ports, inviting more participants, and adding or deleting media streams. Other feasible application examples include video conferencing, streaming multimedia distribution, instant messaging, presence information, file transfer and online games. SIP is as described in RFC 3261, available from the Internet Engineering Task Force (IETF) Network Working Group, November 2000; this document and all other documents describing SIP are hereby incorporated by reference in their entirety for all that they teach.

The term “RTP” as used herein refers to Real-Time Transport Protocol. RTP is as described in Real-Time Transport Protocol (RTP) specification RFC 3550, dated July 2003, by Schulzrinne et al., available from the Internet Engineering Task Force (IETF) Network Working Group; this document and all other documents describing RTP are herein incorporated by reference in their entirety for all that they teach. RTP defines a standardized packet format for delivering audio and video over IP networks. RTP is used extensively in communication and entertainment systems that involve streaming media, such as telephony, video teleconference applications and web-based push to talk features.

The term “Uniform Resource Identifier” (URI) as used herein refers to a string of characters used to identify a name or a resource on the Internet. Such identification enables interaction with representations of the resource over a network using specific protocols. Schemes specifying a concrete syntax and associated protocols define each URI.

The term “Media Server Markup Language” (MSML) as used herein refers to a syntax used to control and invoke many different types of services on IP Media Servers. MSML is as described in RFC 5707RFC, available from the Internet Engineering Task Force (IETF) Network Working Group; this document and all other documents describing MSML are hereby incorporated by reference in their entirety for all that they teach. MSML can allow clients to define how multimedia sessions interact on a Media Server and to apply services to individuals or groups of users. MSML can be used, for example, to control Media Server conferencing features such as video layout and audio mixing, create sidebar conferences or personal mixes, and set the properties of media streams. As well, clients can use MSML to define media processing dialogs, which may be used as parts of application interactions with users or conferences. Transformation of media streams to and from users or conferences as well as IVR dialogs are examples of such interactions, which are specified using MSML. MSML clients may also invoke dialogs with individual users or with groups of conference participants using VoiceXML.

The term “Session Description Protocol” (SDP) as used herein refers to a format for describing streaming media initialization parameters. SDP is intended for describing multimedia communication sessions for the purposes of session announcement, session invitation, and parameter negotiation. SDP does not deliver media itself but is used for negotiation between end points of media type, format, and all associated properties. The set of properties and parameters are often called a session profile. SDP is designed to be extensible to support new media types and formats. SDP is as described in RFC 4566, July 2006, available from the Internet Engineering Task Force (IETF); this document and all other documents describing SDP are hereby incorporated by reference in their entirety for all that they teach.

The term “dialog state event(s)” (DSE) as used herein refers to a state of a communication session or state of a component involved in a communication session. A DSE can be published to subscribing entities to inform the subscribers of changes to the state of the session. DSE is as described in RFC 4235, available from the Internet Engineering Task Force (IETF); this document and all other documents describing DSE are hereby incorporated by reference in their entirety for all that they teach.

The term “network” as used herein refers to a system used by a communication platform to provide communications between communication endpoints. The network can consist of one or more session managers, feature servers, communication endpoints, etc. that allow communications, whether voice or data, between two users. A network can be any network or communication system as described in conjunction with FIGS. 6 and 7. Generally, a network can be a local area network (LAN), a wide area network (WAN), a wireless LAN, a wireless WAN, the Internet, etc. that receives and transmits messages or data between devices to facilitate communication platform activities. A network may communicate in any format or protocol known in the art, such as, transmission control protocol/internet protocol (TCP/IP), 802.11g, 802.11n, Bluetooth, or other formats or protocols.

The term “database” or “data structure” as used herein refers to any system, hardware, software, memory, storage device, firmware, component, etc., that stores data. The data model can be any type of database or storage framework described in conjunction with FIGS. 6 and 7, which is stored on any type of non-transitory, tangible computer readable medium. A database can include one or more data structures, which may comprise one or more sections or portions that store an item of data. A section may include, depending on the type of data structure, an attribute of an object, a data field, or other types of sections included in one or more types of data structures. The data structure can represent a text string or be a component of any type of database, for example, relational databases, flat file databases, object-oriented databases, or other types of databases. Further, the data structures can be stored in memory or memory structures that may be used in either run-time applications or in initializing a communication.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “in communication with” as used herein refers to any coupling, connection, or interaction using electrical signals to exchange information or data, using any system, hardware, software, protocol, or format.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” or “computer program product” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the embodiments are considered to include a tangible storage medium and prior art-recognized equivalents and successor media, in which the software implementations of the present embodiments are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the description includes exemplary embodiments, it should be appreciated that individual aspects of the embodiments can be separately claimed.

### BRIEF DESCRIPTION OF THE DRAWINGS

The present disclosure is described in conjunction with the appended figures:

FIG. 1 is a block diagram of an embodiment of a system for conducting a communication session;

FIG. 2 is a block diagram of an embodiment of an application operable to conduct media services in a communication session;

FIG. 3 is an embodiment of a data structure operable to store information associated with the token;

FIG. 4 is a flow diagram of an embodiment of a process for creating a token incident to establishing a communication session;

FIG. 5 is a flow diagram of an embodiment of a process for creating and sharing a token with a remote application incident to establishing a communication session;

FIG. 6 is a block diagram of an embodiment of a computing environment operable to execute the embodiments described herein;

FIG. 7 is a block diagram of an embodiment of a computer or computing system environment operable to execute as the one or more devices described herein.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

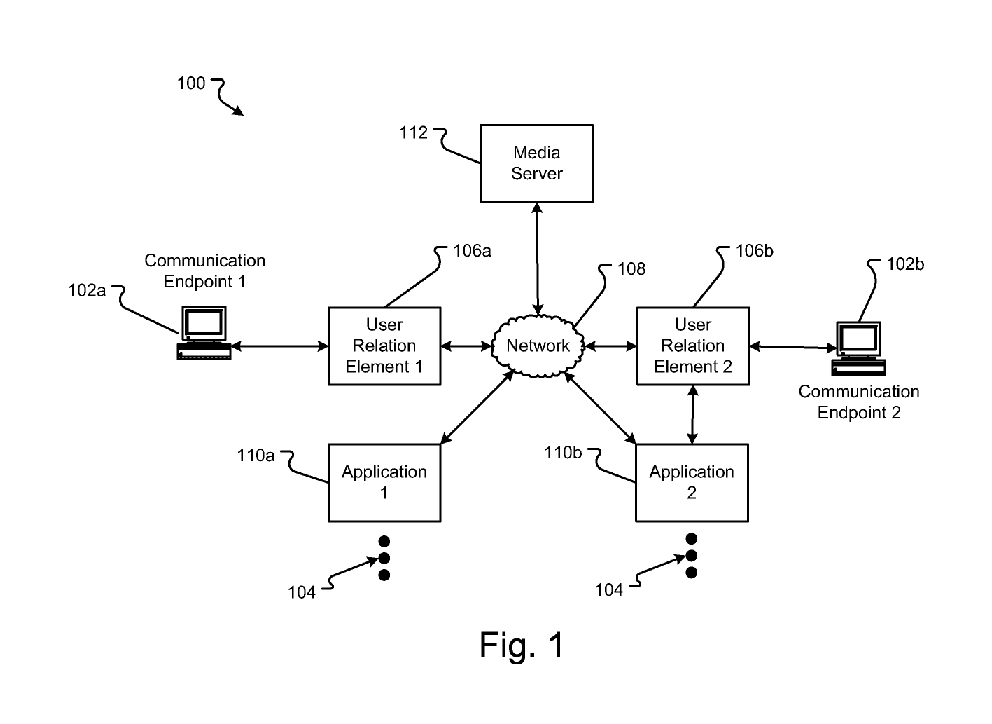

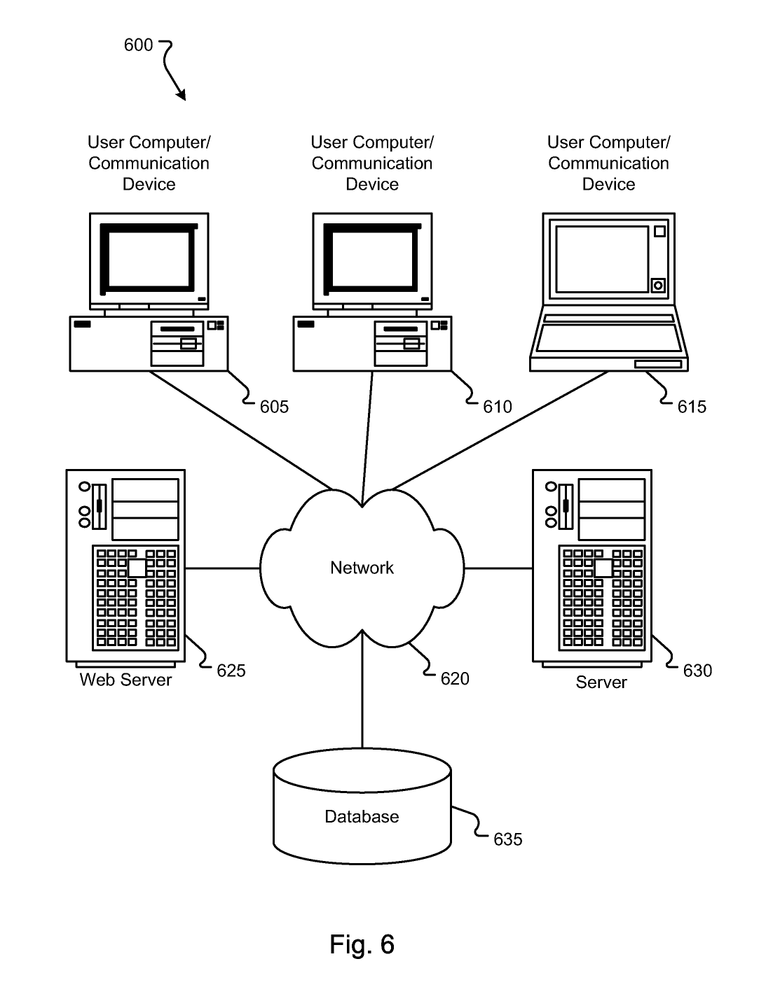

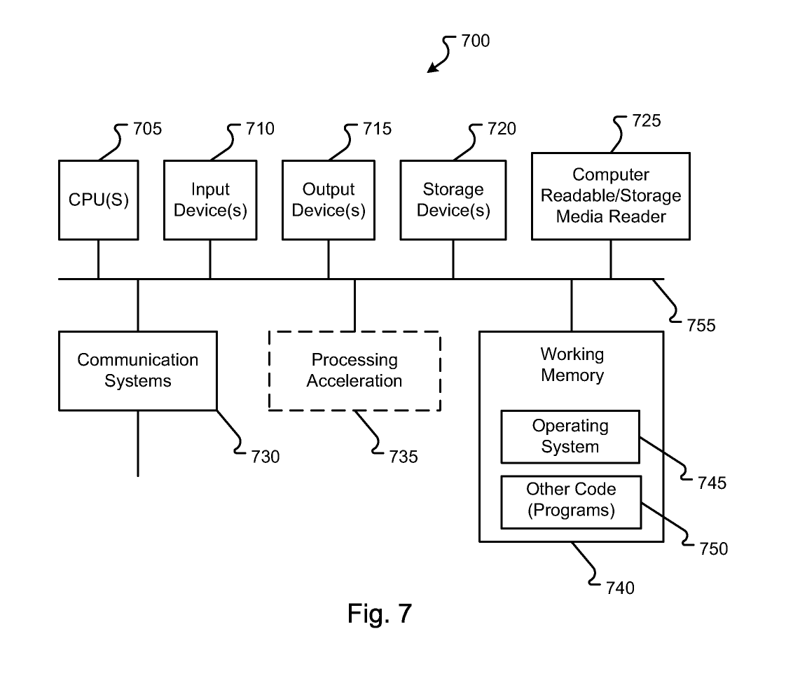

An embodiment of a communication environment 100 is shown in FIG. 1. The communication system 100 can be an IMS architecture, an MSML architecture, some other architecture, or a combination of these or different architectures that allow and facilitate communications between two or more communication endpoints 102 and exchanging media or executing media applications 110 (also referred to as applications). In an embodiment, the communication system 100 is a combined IMS and MSML architecture. The one or more components shown in FIG. 1 can be hardware and/or software operable to execute the functions described herein. In embodiments, the components in FIG. 1 can be computer systems as described in conjunction with FIGS. 6 and 7 and/or the applications or software executed by the computer systems as described in conjunction with FIGS. 6 and 7. The environment 100 can include two or more communication endpoints 102, one or more feature sequencers (FSs) 106, a network 108, one or more applications 110, and a media server 112.

A communication endpoint 102a or 102b is operable to begin and conduct a communication session with one or more other communication endpoints 102. The communication endpoint 102 can communicate with a FS 106 to initiate the communication session. A communication endpoint 102 is also operable to send media, such as, voice, video, text, or other media to an application 110 or another communication endpoint 102. In the example shown in FIG. 1, a first communication endpoint 102a communicates with a second communication endpoint 102b in a communication session.

In accordance with at least some embodiments, the feature sequencer 106 can determine an application sequence and cause one or more applications 110 to be sequenced into a communication session. In particular, the feature sequencer 106 is configured to analyze a particular user's communication preferences and invoke the necessary applications 110 to fulfill such preferences. Once an application sequence is determined, by the feature sequencer 128, the communications server 124 passes the communication-establishing message to a first application in the application sequence, thereby allowing the first application to determine the parameters of the communication session, insert itself into the control and/or media stream of the communication session, and thereby bind itself to the communication session. Once the first application has inserted itself into the communication session, the first application either passes the communication-establishing message back to the feature sequencer 128 to identify the next application in the application sequence or passes the communication-establishing message directly to a second application in the application sequence. Alternatively, or in addition, the message may be redirected, rejected, or the like. Moreover, parties and/or media servers may be added to the call by an application. As can be appreciated, this process continues until all applications have been included in the communication session and the process can be duplicated for each of the users involved in the communication session.

A FS 106 is operable to establish a communication session for communication endpoints 102. The FS 106 may be able to communicate with other Feature Sequencers 106 or other communication endpoints 102 using one or more communication protocols. For example, the FS 106 may communicate using one or a combination of SIP, RTP, SDP, or other protocols used to establish communication sessions or communicate media to one or more destinations. A first FS 106a may communicate through a network 108 to a second FS 106b to establish the communication session. Further, the FS 106 can communicate with one or more media applications 110 that provide media services to the communication endpoints 102.

A media server 112 can be a system, server, or other hardware and/or software operable to provide communication channels, ports, media services, etc., for the communication session. The media server 112 can allow for communications between communication endpoints 102 through a network 108. Further, the media server 112 can also enable additional media functionality, such as, but not limited to, playing messages, recording communications, transcoding, etc. The media server 112 establishes which port each of the applications 110 or communication endpoints 102 use in communicating between different components shown in FIG. 1.

One or more media applications 110 can provide media services to the users of the communication endpoints 102. There may be more or fewer applications than those shown in FIG. 1 as represented by ellipses 104. The applications 110 can include, for example, a personal assistant application, a call recording application, IVR applications, an announcement application, or other applications operable to exchange media or provide media to a user and/or communication endpoints 102. The media applications 110 require communication channels to send or receive media data.

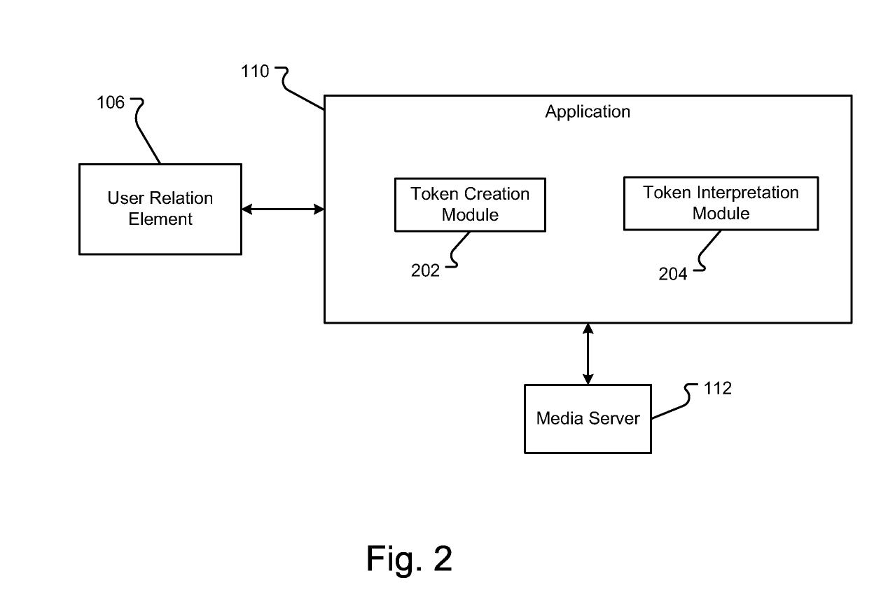

An embodiment of an application 110 is shown in FIG. 2. An application 110 requires access to a media server port to communicate media, data, or information. Embodiments herein can share ports as opposed to establishing new ports for the applications 110. To share the ports, a token is created that is used by the various applications 100 for accessing the already allocated ports. The media server 112 can regulate which media application 110 or other component in the environment in FIG. 1 can send or receive media information at any given time based on which component possesses the token.

The token, in embodiments presented herein, can be created by the one or more media applications 110. As such, the application 110 can include a token creation module 202 and/or a token interpretation module 204. While the token creation module 202 and token interpretation module 204 are shown as part of application 110, in alternative embodiments, the modules 202 and 204 may be separate services or applications accessed by the application 110 but executed by separate components and/or systems. Thus, modules 202 and 204 may not be part of the application 110 as shown in FIG. 2 but separate there from.

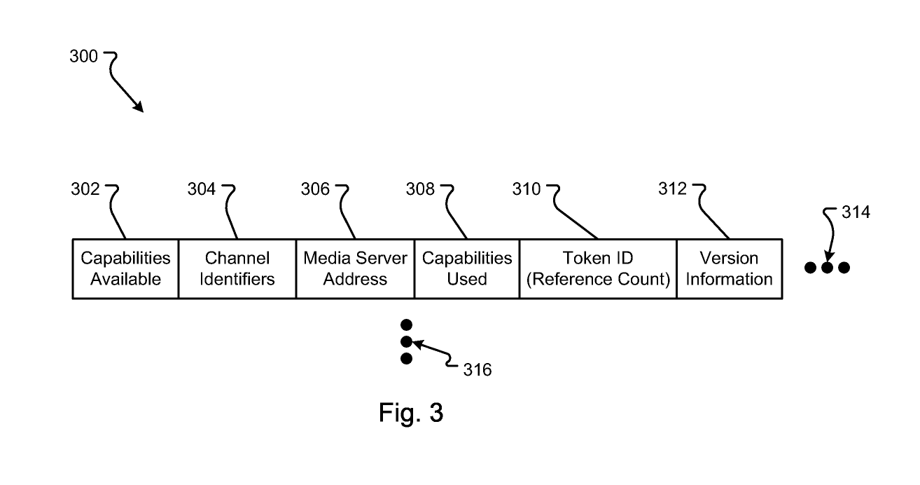

A token creation module 202 is operable to create the token. The token creation module 202 can determine the information required for the token, such as the media server enabling the communication session or providing media services. The token creation module 202 may then form the data structure used for the token, of which an embodiment is shown in FIG. 3. Further, the token creation module 202 may send or share the token with one or more components or applications 110. Possession of the token allows the application or component to use ports or other media services assigned to the communication session and delineated in the token.

The token interpretation module 204 is operable to receive, read, and interpret the token created by another component or application 110. Thus, the token interpretation module 204 can read the information included in the token, as shown in FIG. 3, and apply the information to use the ports or media services. The token interpretation module 204 is further operable to store the token or the information included therein in a cache, database, or other storage system.

An embodiment of a token is shown in FIG. 3. The token 300 can include one or more portions stored in a data structure or other type of data storage component. The token may include more or fewer portions than those shown in FIG. 3, as represented by ellipses 314. A single token is shown in FIG. 3 but there may be more tokens used by the media environment shown in FIG. 1, as represented by ellipses 316. Embodiments of the token can include portions for storing data associated with capabilities available 302, channel identifiers 304, media server address 306, capabilities used 308, token identifier 310, version information 312, or other information.

The capabilities available data 302 can include any capability of the media server 112 or other information about how the media server 112 operates. For example, the capabilities can include the capacities on each port or channel, what services the media server 112 may be able to execute, or other information about the functioning or abilities of the media server 112. Further, the capabilities available 302 may also list operational information, such as, what protocols the media server 112 uses to communicate or other information about how to interact or communicate with the media server 112.

The channel identifier or identifiers 304 can include one or more identifiers for the channel or port to be used with the token. Thus, the token is associated with a certain set of pre-assigned channels or ports on the media server 112. Thus, when the application 110 or FS 106 communicates using the token, the FS 106 or application 110 uses the ports identified by the channel identifiers 304. There may be one or more ports identified in the channel identifiers 304.

The media server address 306 can be any address or identifier for the media server 112. In one embodiment, the media server address 306 is an URI. In other embodiments, the media server address 306 can be another type of address used in the function of the network 108.

The capabilities used 308 can be any capabilities currently being used by the application or applications 110 associated with the token or capabilities used by other applications 110 that may not be available until released by those other applications 110. Thus, the capabilities used 208 can include a subset of or all capabilities listed under the capabilities available 302. These used capabilities 208 can also include some or all the capabilities used by applications 110 that have been associated with the token 300.

The token ID 310 can be any identifier for the token 300. The token ID 310 can be any identifier that uniquely identifies a first token 300 from other tokens being used by one or more other applications 100 or in other communication sessions. In embodiments, the token ID 310 is a globally unique identifier (GUID). In other embodiments, the token ID 310 may be a reference count. A reference count can be a chronologic indicator associated with when the token was created, wherein every time a token is issued, the reference count increments one point or one measure. Thus, a first token can have a token ID 310 of one (1) while a second token will have a token ID 310 of two (2).

Version information 312 can be any information about the version of the token or software associated with token or information regarding services or software associated with the media server 112. The version information 312 can list the type and version of software associated with media server 112 for the component requesting the token.

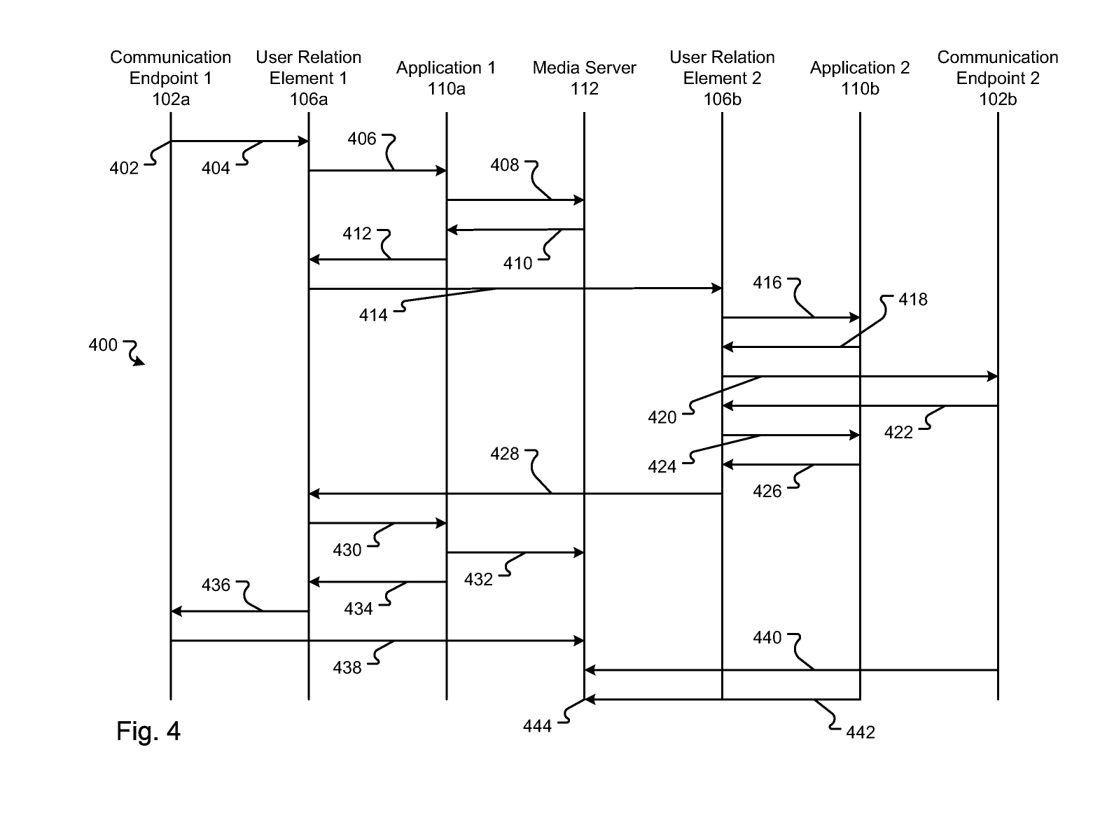

An embodiment of a method 400 for establishing a port, resource, or other service of a media server, to be used by one or more applications 110 during communication session, is shown in FIG. 4. Generally, the method 400 begins with a start operation 402 and terminates with an end operation 444. While a general order for the steps of the method 400 are shown in FIG. 4, the method 400 can include more or fewer steps or arrange the order of the steps differently than those shown in FIG. 4. The method 400 can be executed as a set of computer-executable instructions executed by a computer system and encoded or stored on a computer readable medium. Hereinafter, the method 400 shall be explained with reference to the systems, components, modules, data structures, user interfaces, etc. described in conjunction with FIGS. 1-3.

Communication endpoint 102a can send an INVITE message, with SDP offer, to join a second communication endpoint 102b into a communication session, in step 404. The INVITE can be communicated from the communication endpoint 102a to the FS 1 106a. The SIP message includes information about what type of communication session is to be established. One or more applications 110 may be associated with the user or the user's FS 106a. The applications 110 can be in sequence. Thus, when a communication session is established, the applications 110 can be automatically initiated. As such, the INVITE might be communicated to an in-sequence application 110a, in step 406. Here, the INVITE is sent from the FS 106a to a first application 110a. The application 110a can be any application used or associated with the user, such as a call recording application, personal assistant application, or other application. The application 110a can then work to establish the communication session and create a token.

The first application 110a can send a SIP INVITE including SDP offer, to establish a control channel, to a media server 112, in step 408. Thus, the first application 110a is able to interact with the media server 112 directly to establish the control channel for the communication session to be used by the application 110a or other applications 110 associated with the user. The SDP offer allows the media server 112 to establish the correct type of services and/or resources for the communication session. The media server 112 can determine and set the control channel, ports, services, and other configurations for the communication session.

The media server 112 can then send a 200 OK including SDP answer to the first application 110a, to communicate what resources are reserved and other information about the port or channel to which the application 110a should use in communicating in the communication session. This information provided by the media server 112 may be the same as that described in conjunction with FIG. 3. The media application 110a can then create the token from the information received from the media server 112.

In embodiments, the token may be stored as a header of the SIP INVITE or other message associated with the SIP session. Thus, in establishing the communication session, through SIP messages, the FS 106a can communicate the token to other applications 110 associated with either the first or second user. And the token communicates the data describing any assigned ports, channel, services, etc. The reserved resources by the media server 112 can be based on an SDP answer relayed from FS 106a and an offer relayed from FS 106b. In embodiments, the token may be an eXtensible Markup Language (XML) schema stored as a header in the SIP INVITE or other message associated with the SIP INVITE. Further, a token may only include a media server address and an opaque media session identifier that can then be used to query the media server 112 for the details about the communication session.

The token may then be communicated back to the FS 106a from the application 110a with the SIP INVITE message, in step 412. The FS 106a, after receiving the INVITE message, can then communicate with another FS 106b to establish a communication session with the other communication endpoint 102b. The FS 106a sends the SIP INVITE to establish the communication session, which includes the token, to the FS 106b associated with the other user, in step 414. In an embodiment, the first FS 106a sends the INVITE with the token directly to the second FS 106b. In other embodiments, the first FS 106a may publish the token as a part of a DSE, such that any other components subscribing to the user's DSEs may receive the information about the token. In still further embodiments, the FS 106a may publish the token to a communication endpoint or other element in the communication system.

The received SIP INVITE, with the token, may then be sent from the second FS 106b to a second application 110b, in step 416. The second application 110b can cache the token, such that the token can be used by the second application 110b or other applications 110 associated with the second user. The SIP INVITE, with the token, is then sent back to the FS 106b, in step 418, and then the FS 106b sends the SIP INVITE and the token to the second communication endpoint 102b that is associated with the second user, in step 420.

The second communication endpoint 102b can then accept the SIP INVITE to establish a communication session. After accepting the SIP INVITE, the second communication endpoint 102b can then send a 200 OK including an SDP answer back to the FS 106b. The 200 OK including the SDP answer may then be transmitted from the FS 106b to the second application 106b, in step 424. The token may be returned with the 200 OK message, which is sent from the application 110b to the FS 106b, in step 426. The 200 OK response is then sent from the FS 106b to the first FS 106a, in step 428.

The FS 106a may then relay the 200 OK message to the application 110a, in step 430. The 200 OK message including the SDP answer can then be sent from the application 110a to the media server 112, in step 432. This message allows the media server 112 to establish a control channel with application 110a, both FSs 106a and 106b, and both communication endpoints 102a and 102b. The 200 OK message, with the media server 112 SDP answer, is then sent back to the FS 106a from the application 110a, in step 434. The FS can then send the 200 OK message including the media server SDP answer to the communication endpoint 102a, in step 436. The receipt of the 200 OK message at the communication endpoint 102a establishes the communication session. Both communication endpoints 102 can then exchange RTP packets with the media server 112. For example, communication endpoint 102a can establish an RTP channel with the media server 112, in step 438. Meanwhile, communication endpoint 102b can also establish an RTP channel with the media server 112, in step 440. Further, the second application 110b can also establish a control channel with the media server 112, in step 442, to conduct media services for the user using the token.

This method 400 allows the creation of tokens for a communication session(s). The first application 110a establishes the resources for the communication session when the control channel with the media server 112 is established. The establishment of the control channel reserves certain ports, communication channels, and/or media services for applications 110 associated with the users associated with the communication session. To use the port or channel, an application 110 or other component obtains the information for the reserved resources from the token. The media server 112 can moderate which application 110 or component uses the reserved resources. Thus, a group of applications 110 and components can use the same channel(s) or port(s) to communicate without having to establish new channels or ports. Thus, this method 400 provides for a more efficient use of resources of the media server 112 and prevents the added overhead of creating extra ports or channels for applications 110. In addition, the token method 400 also better utilizes the bandwidth or capacity of the ports or channels already assigned to the communication session.

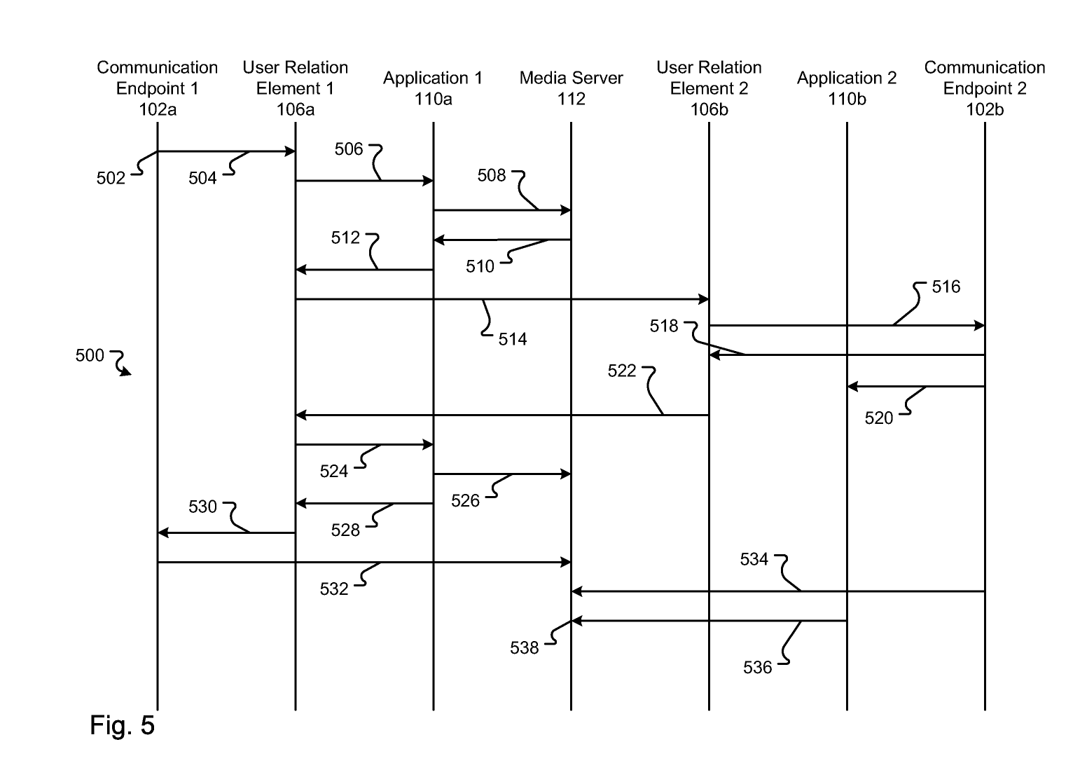

An embodiment of a method 500 for establishing a port, resource, or other service of a media server 112, to be used by one or more applications 110 (including a remote application) during communication session, is shown in FIG. 5. Generally, the method 500 begins with a start operation 502 and terminates with an end operation 538. While a general order for the steps of the method 500 are shown in FIG. 5, the method 500 can include more or fewer steps or arrange the order of the steps differently than those shown in FIG. 5. The method 500 can be executed as a set of computer-executable instructions executed by a computer system and encoded or stored on a computer readable medium. Hereinafter, the method 500 shall be explained with reference to the systems, components, modules, data structures, user interfaces, etc. described in conjunction with FIGS. 1-3.

Communication endpoint 102a can send an INVITE message, with SDP offer, to join a second communication endpoint 102b into a communication session, in step 504. The INVITE can be communicated from the communication endpoint 102a to the FS 1 106a. The SIP message includes information about what type of communication session is to be established. One or more applications 110 may be associated with the user or the user's FS 106a. The first application 110a may be in sequence. However, the second user may be using remote applications 110b that are not in sequence. For the in sequence applications 110a, when a communication session is established, the applications 110 can be automatically initiated. As such, the INVITE might be communicated to the in-sequence application 110a, in step 506. Here, the INVITE is sent from the FS 106a to the first application 110a. The application 110a can be any application used or associated with the first user, such as a call recording application, personal assistant application, or other application. The application 110a can then work to establish the communication session and create a token.

The first application 110a can send a SIP INVITE including SDP offer, to establish a control channel, to a media server 112, in step 508. Thus, the first application 110a is able to interact with the media server 112 directly to establish the control channel for the communication session to be used by the application 110a or other applications 110 associated with the first or second user. The SDP offer allows the media server 112 to establish the correct type of services and/or resources for the communication session. The media server 112 can determine and set the control channel, ports, services, and/or other configurations for the communication session.

The media server 112 can then send a 200 OK including SDP answer to the first application 110a, to communicate what resources are reserved and other information about the port or channel to which the application 110a should use in communicating in the communication session. This information, provided by the media server 112, may be the same as that described in conjunction with FIG. 3. The media application 110a can then create the token from the information received from the media server 112.

In embodiments, the token may be an eXtensible Markup Language (XML) schema stored as a header in the SIP INVITE or other message associated with the SIP session. Thus, in establishing the communication session, through SDP offers and answers and SIP INVITEs and responses, the FS 106a can communicate the token to other applications 110 associated with either the first or second user. And the token communicates the data describing any assigned ports, channel, services, etc. The reserved resources by the media server 112 can be based on an SDP answer from FS 106a and an SDP offer from FS 106b.

The token may then be communicated back to the FS 106a from the application 110a with the SIP INVITE message, in step 512. The FS 106a, after receiving the token, can then communicate with another communication endpoint 102b to establish a communication session. The FS 106a then sends the SIP INVITE to establish the communication session, which includes the token, to the FS 106b associated with the other user, in step 514. In an embodiment, the first FS 106a sends the SIP INVITE with the token directly to the second FS 106b. In other embodiments, the first FS 106a may publish the token as a part of a DSE, such that any other components subscribing to the user's DSEs may receive the information about the token. The received SIP INVITE, with the token, may then be sent from the second FS 106b to a second communication device 102b, in step 516. Here, the second application 110b is an application that is not in sequence. As such, the second application 110b can access the media server 112 to send the SIP INVITE as described in FIG. 4, but the out-of-sequence application 110b cannot obtain the information in the token that is in the INVITE message. Thus, the second communication device 102b can cache the token and publish it in DSE, such that the token can be used by the second application 110b or other applications 110 associated with the second user.

The second communication endpoint 102b can then accept the SIP INVITE to establish a communication session. After accepting the SIP INVITE, the second communication endpoint 102b can then send a 200 OK including an SDP response back to the FS 106b, in step 518. The second communication device 102b may then publish a DSE, which can include the token, in step 520. The second application 110b may subscribe to and receive the DSE with the token. The second application may then interpret the token to establish a control channel with the media server 112 to conduct media services, in step 536. The 200 OK is sent from the FS 106b to the first FS 106a, in step 522.

The FS 106a may then relay the 200 OK message to the application 110a, in step 524. The 200 OK message including the SDP answer can then be sent from the application 110a to the media server 112, in step 526. This message allows the media server 112 to establish a control channel with application 110a, both Feature Sequencers 106a and 106b, and/or both communication endpoints 102a and 102b. The 200 OK message with the SDP answer is then sent back to the FS 106a from the application 110a, in step 528. The FS 106a can then send the 200 OK message including the updated SDP answer to the communication endpoint 102a, in step 530. The receipt of the 200 OK message at the communication endpoint 102a establishes the communication session. Both communication endpoints 102 RTP packets with the media server 112. For example, communication endpoint 102a can establish an RTP channel with the media server 112, in step 532. Meanwhile, communication endpoint 102b can also establish an RTP channel with the media server 112, in step 534. Further, the second application 110b can also establish a control channel with the media server 112, in step 536, to conduct media services for the user using the token.

This method 500 allows the creation of tokens for a communication session(s) that enables out-of-sequence remote applications to apply media services to the communication session. The first application 110a establishes the resources for the communication session when the control channel with the media server 112 is established. The establishment of the token control channel reserves certain ports, communication channels, and/or media services for applications 110 associated with the users associated with the communication session. To use the port or channel, an application 110 or other component reserves obtains the information for the reserved resources from the token and then sends and receives the information while the token is reserved. The media server 112 can moderate which application 110 or component uses the reserved resources. Thus, a group of applications 110 and components can use the same channel(s) or port(s) to communicate without having to establish new channels or ports. Thus, this method 400 provides for a more efficient use of resources of the media server 112 and prevents the added overhead of creating extra ports or channels for applications 110. In addition, the token method 400 also better utilizes the bandwidth or capacity of the ports or channels already assigned to the communication session.

FIG. 6 illustrates a block diagram of a computing environment 600 that may function as system or environment for the embodiments described herein. The system 600 includes one or more user computers 605, 610, and 615. The user computers 605, 610, and 615 may be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 605, 610, 615 may also have any of a variety of applications, including for example, database client and/or server applications, and web browser applications. Alternatively, the user computers 605, 610, and 615 may be any other electronic device, such as a thin-client computer, Internet-enabled mobile telephone, and/or personal digital assistant, capable of communicating via a network (e.g., the network 620 described below) and/or displaying and navigating web pages or other types of electronic documents. Although the exemplary system 600 is shown with three user computers, any number of user computers may be supported.

System 600 further includes a network 620. The network 620 can be any type of network familiar to those skilled in the art that can support data communications using any of a variety of commercially-available protocols, including, without limitation, TCP/IP, SNA, IPX, AppleTalk, and the like. Merely by way of example, the network 620 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth™ protocol known in the art, and/or any other wireless protocol); and/or any combination of these and/or other networks.

The system 600 may also include one or more server computers 625, 630. One server may be a web server 625, which may be used to process requests for web pages or other electronic documents from user computers 605, 610, and 615. The web server can be running an operating system including any of those discussed above, as well as any commercially-available server operating systems. The web server 625 can also run a variety of server applications, including HTTP servers, FTP servers, CGI servers, database servers, Java servers, and the like. In some instances, the web server 625 may publish operations available operations as one or more web services.

The system 600 may also include one or more file and or/application servers 630, which can, in addition to an operating system, include one or more applications accessible by a client running on one or more of the user computers 605, 610, 615. The server(s) 630 may be one or more general purpose computers capable of executing programs or scripts in response to the user computers 605, 610 and 615. As one example, the server may execute one or more web applications. The web application may be implemented as one or more scripts or programs written in any programming language, such as Java™, C, C#™ or C++, and/or any scripting language, such as Perl, Python, or TCL, as well as combinations of any programming/scripting languages. The application server(s) 630 may also include database servers, including without limitation those commercially available from Oracle, Microsoft, Sybase™, IBM™ and the like, which can process requests from database clients running on a user computer 605.

The web pages created by the web application server 630 may be forwarded to a user computer 605 via a web server 625. Similarly, the web server 625 may be able to receive web page requests, web services invocations, and/or input data from a user computer 605 and can forward the web page requests and/or input data to the web application server 630. In further embodiments, the server 630 may function as a file server. Although for ease of description, FIG. 5 illustrates a separate web server 625 and file/application server 630, those skilled in the art will recognize that the functions described with respect to servers 625, 630 may be performed by a single server and/or a plurality of specialized servers, depending on implementation-specific needs and parameters. The computer systems 605, 610, and 615, file server 625 and/or application server 630 may function as servers or other systems described herein.

The system 600 may also include a database 635. The database 635 may reside in a variety of locations. By way of example, database 635 may reside on a storage medium local to (and/or resident in) one or more of the computers 605, 610, 615, 625, 630. Alternatively, it may be remote from any or all of the computers 605, 610, 615, 625, 630, and in communication (e.g., via the network 620) with one or more of these. In a particular set of embodiments, the database 635 may reside in a storage-area network (“SAN”) familiar to those skilled in the art. Similarly, any necessary files for performing the functions attributed to the computers 605, 610, 615, 625, 630 may be stored locally on the respective computer and/or remotely, as appropriate. In one set of embodiments, the database 635 may be a relational database, such as Oracle 10i™, that is adapted to store, update, and retrieve data in response to SQL-formatted commands. Database 635 may be the same or similar to the database used herein.

FIG. 7 illustrates one embodiment of a computer system 700 upon which servers or other systems described herein may be deployed or executed. The computer system 700 is shown comprising hardware elements that may be electrically coupled via a bus 755. The hardware elements may include one or more central processing units (CPUs) 705; one or more input devices 710 (e.g., a mouse, a keyboard, etc.); and one or more output devices 715 (e.g., a display device, a printer, etc.). The computer system 700 may also include one or more storage device 720. By way of example, storage device(s) 720 may be disk drives, optical storage devices, solid-state storage device such as a random access memory (“RAM”) and/or a read-only memory (“ROM”), which can be programmable, flash-updateable and/or the like.

The computer system 700 may additionally include a computer-readable storage media reader 725; a communications system 730 (e.g., a modem, a network card (wireless or wired), an infra-red communication device, etc.); and working memory 740, which may include RAM and ROM devices as described above. In some embodiments, the computer system 700 may also include a processing acceleration unit 735, which can include a DSP, a special-purpose processor and/or the like.

The computer-readable storage media reader 725 can further be connected to a computer-readable storage medium, together (and, optionally, in combination with storage device(s) 720) comprehensively representing remote, local, fixed, and/or removable storage devices plus storage media for temporarily and/or more permanently containing computer-readable information. The communications system 730 may permit data to be exchanged with the network 720 and/or any other computer described above with respect to the system 700. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 700 may also comprise software elements, shown as being currently located within a working memory 740, including an operating system 745 and/or other code 750, such as program code implementing the servers or devices described herein. It should be appreciated that alternate embodiments of a computer system 700 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other types of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the embodiments have been described in detail herein, it is to be understood that the inventive concepts may be otherwise variously embodied and employed, and that the appended claims are intended to be construed to include such variations, except as limited by the prior art.

What is claimed is:

1. A computer program product including computer executable instructions stored onto a computer readable medium which, when executed by a processor of a computer, causes the computer to perform a method for establishing a communication session, the instructions comprising:
instructions to receive an INVITE for the communication session associated with a first communication endpoint;
instructions to establish a control channel with a media server based on the INVITE; and
instructions to create a token associated with the communication session.

2. The computer program product as defined in claim 1, further comprising instructions to share the token to communicate data during the communication session.

3. The computer program product as defined in claim 2, wherein a first media application creates the token.

4. The computer program product as defined in claim 3, wherein the first media token shares the token with one or more other media applications.

5. The computer program product as defined in claim 1, wherein the INVITE includes an SDP offer.

6. The computer program product as defined in claim 1, further comprising instructions to communicate the token to at least one of a communication endpoint or a media application.

7. The computer program product as defined in claim 6, wherein the token is an XML encoded schema incorporated into a header or body of a SIP message.

8. The computer program product as defined in claim 6, wherein the token is communicated as information in a DSE message.

9. The computer program product as defined in claim 1, further comprising:
instructions to receive the token at a second application;
instructions to interpret the token; and
instructions to create a control channel for the second application using information in the token.

10. The computer program product as defined in claim 9, wherein the second application is not directly in the signaling path between the two communication endpoints.

11. The computer program product as defined in claim 1, wherein the token is an XML encoded schema incorporated into a header of a SIP message.

12. The computer program product as defined in claim 1, wherein the token includes a token that includes a media server address and an opaque communication session identifier that is used to query the media server for the details about the communication session

13. A method for sharing a communication channel during a communication session, comprising:
a first feature sequencer receiving a request from a first communication endpoint to establish a communication session with a second communication endpoint;
the first feature sequencer sending the request to a first application, wherein the first application is in-sequence;
the first application communicating with a media server to establish a control channel for the communication session;
the first application creating a token;
the first application sending the token to the first feature sequencer;
the first feature sequencer sending an INVITE for the communication session, wherein the INVITE includes the token;
the first feature sequencer sending the INVITE to the second communication endpoint;
the second communication endpoint sending an acceptance of the INVITE;
sending the acceptance to the first feature sequencer to be relayed to the first communication endpoint to establish the communication session;
and
wherein during the communication session, the first application negotiates with the media server for resources listed in the token.

14. The method as defined in claim 13, wherein the INVITE is a SIP INVITE and the token is a header in the SIP INVITE.

15. The method as defined in claim 14, wherein the second application is not in sequence.

16. The method as defined in claim 15, wherein the token is an XML encoded schema incorporated into a header of a SIP message.

17. The method as defined in claim 16, wherein the token includes a token that includes a media server address and an opaque media session identifier that is used to query the media server for the details about the communication session.

18. A communication system comprising:
a first communication device comprising:
a memory;
a processor in communication with the memory, the processor operable to send a SIP INVITE for a communication session with a second communication endpoint;
a computing device comprising:
a second memory;
a second processor in communication with the second memory, the second processor operable to execute a first media application, the first media application operable to:
receive the SIP INVITE;
operable to communicate with a media server to establish a control channel for the communication session; and
operable to create a token associated with the control channel, wherein possession of token provides access to a communication channel.

19. The communication system as defined in claim 18, wherein the first media application includes a token creation module to create the token.

20. The communication system as defined in claim 18, further comprising a second media application, the second media application operable to:
receive the token from the first media application;
interpret the token;
cache the token, wherein the second media application can obtain the token to receive access to the communication channel.

21. The communication system as defined in claim 20, wherein the second media application includes a token interpretation module to understand information in the token.

22. The communication system as defined in claim 20, wherein one or more other applications share the token to access the communication channel.
